(19) United States
(12) Patent Application Publication
(10) Pub. No.: US 2008/0174801 A1
(43) Pub. Date: Jul. 24, 2008

(54) Image Forming Data Preprocessing System, Image Forming Apparatus and Computer

(75) Inventor: Daisuke ASAI, Seto-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/016,393

(22) Filed: Jan. 18, 2008

(30) Foreign Application Priority Data
Jan. 19, 2007 (JP) 2007-010114

(51) Int. Cl. H04N 1/60

(52) U.S. Cl. 358/1.9

(57) ABSTRACT

An image forming data preprocessing system for preprocessing first image forming data decides whether the first image forming data contains an object of a specific type or not. The system executes a suppression processing if it is decided that the first image forming data contains the object of the specific type. The suppression processing includes converting at least a part of the image forming data to provide second image forming data. The second image forming data is smaller in a required colorant consumption amount than the first image forming data.

### CROSS REFERENCE TO RELATED APPLICATION

The present disclosure relates to the subject matter contained in Japanese patent application No. 2007-010114 filed on Jan. 19, 2007, which is expressly incorporated herein by reference in its entirety.

### TECHNICAL FIELD

The present invention relates to an image forming data preprocessing system, an image forming apparatus and a computer.

JP-A-2005-121993 discloses an image forming apparatus for forming a color image on a recording medium such as a sheet or an OHP sheet based on image forming data.

Prior to forming a color image, the image forming apparatus calculates a required consumption amount of a colorant based on image forming data for each color, and decides whether the required consumption amount of each colorant is larger than a preset permissible consumption amount of each colorant or not.

If the required consumption amount of a colorant for one color is larger than the permissible consumption amount for the one color, the image forming apparatus simply converts data on the one color, included in the image forming data, into data on another color.

This way, the image forming apparatus can suppress consumption of the colorants and save the colorants

However, the image forming apparatus is configured to simply convert data on one color into data on another color if the required colorant consumption amount of the one color is decided to be larger than the permissible colorant consumption amount of the one color. In some cases, therefore, it is impossible to sufficiently meet the needs of a user.

As a specific example, in the case in which a text having a color character and a black character mixed therein and an image having a chromatic color are included in the image forming data, the text may be subjected to a color conversion and the color conversion is not desirable for the image. Thus, it is impossible to take a proper countermeasure based on a type of an object. Therefore, it is impossible to meet the needs of the user well.

As one of illustrative, non-limiting embodiments, the present invention can provides an image forming data preprocessing system for preprocessing first image forming data. The system decides whether the first image forming data contains an object of a specific type or not. The system executes a suppression processing if it is decided that the first image forming data contains the object of the specific type. The suppression processing includes converting at least a part of the image forming data to provide second image forming data. The second image forming data is smaller in a required colorant consumption amount than the first image forming data.

Accordingly, one of advantages of the present invention is capable of suppressing a consumption of a colorant. Another one of the advantages of the present invention is capable of meeting various needs of a user.

These and other advantages of the present invention will be discussed in detail with reference to the accompanying drawings.

### BRIEF DESCRIPTION OF THE DRAWINGS

FIG. 1 is a schematic sectional view showing a laser printer comprising an image forming data preprocessing system according to a first embodiment.

FIG. 2 is a typical view showing structures of the laser printer comprising the image forming data preprocessing system according to the first embodiment and a computer.

FIG. 3 is a flowchart showing a processing related to the image forming data preprocessing system according to the first embodiment.

FIG. 4 is a flowchart showing a processing related to an image forming data preprocessing system according to a second embodiment.

### DESCRIPTION OF THE PREFERRED EMBODIMENT

Illustrative, non-limiting embodiments of the invention will be described below with reference to the drawings.

### First Embodiment

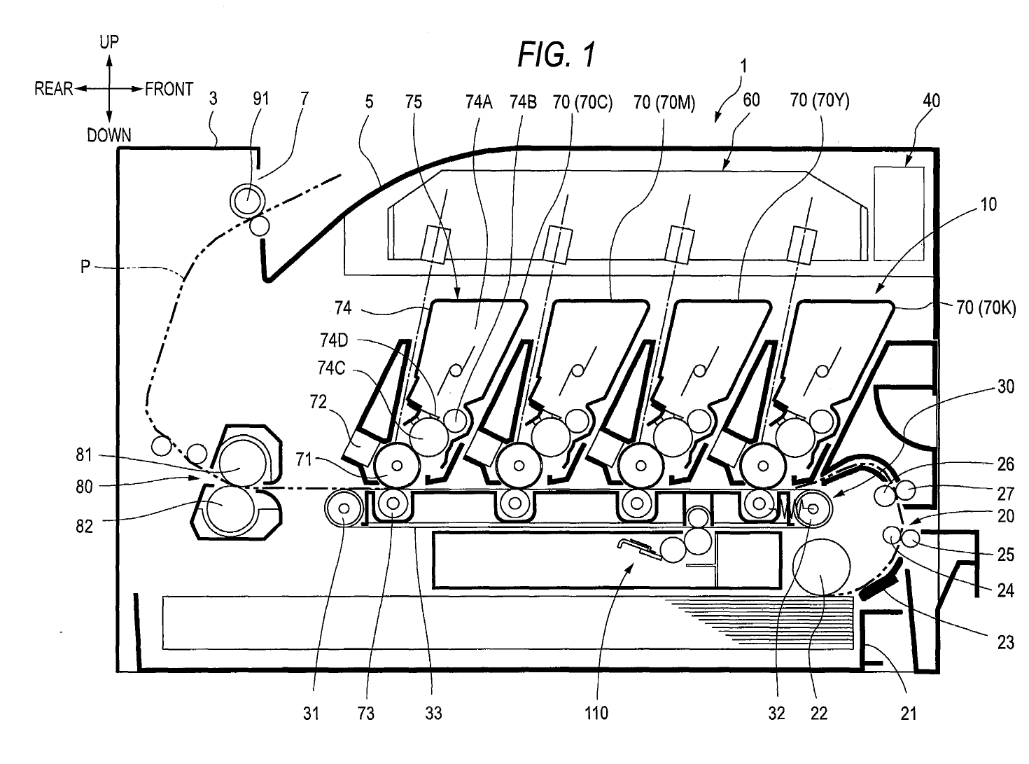

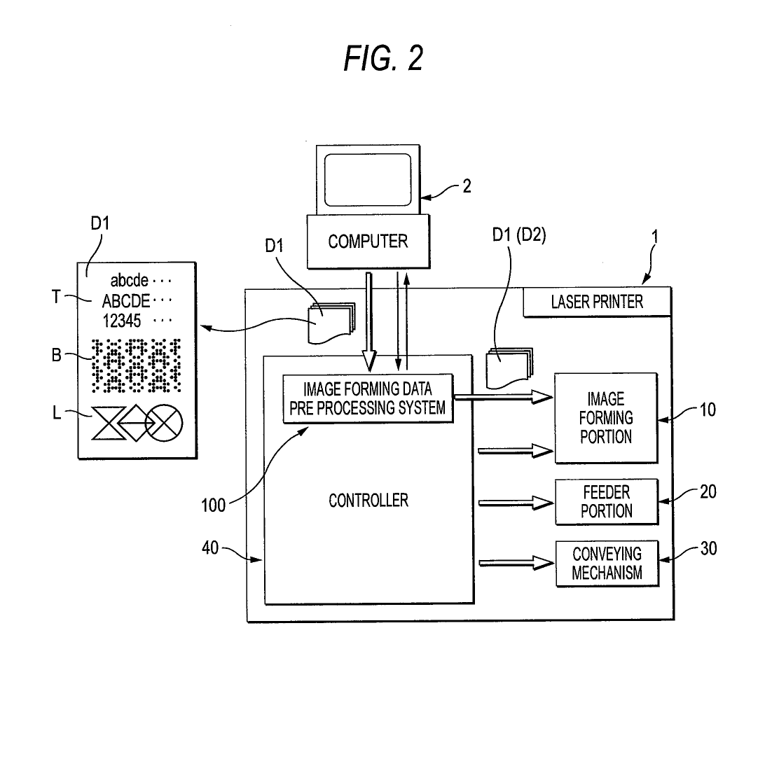

As shown in FIGS. 1 and 2, an image forming data preprocessing system 100 according to a first illustrative, non-limiting embodiment is applied to a laser printer 1. This invention can also be applied to other types of an image forming apparatus such as an ink jet printer, a copying machine, a facsimile machine and a multi-function printer. The laser printer 1 can form a color image on a recording medium, such as a sheet or an OHP sheet (which will be hereinafter referred to as a sheet), by using toners having four colors of black, yellow, magenta and cyan as colorants. First of all, description will be given to a specific structure of the laser printer 1, and furthermore, description will be given to a specific structure of the image forming data preprocessing system 100.

1. Structure of Laser Printer

As shown in FIG. 1, the laser printer 1 is disposed such that an upper side in FIG. 1 corresponds to an upper side in a gravity direction and a right side in FIG. 1 generally corresponds to be a front side. The laser printer 1 includes a controller 40, a feeder portion 20, a conveying mechanism 30 and an image forming portion 10 in a substantially box-shaped (rectangular parallelepiped) housing 3. Moreover, an upper surface side of the housing 3 is provided with a sheet discharging tray 5 on which a sheet subjected to an image formation and discharged from the housing 3 is mounted thereon.

2. Controller

As shown in FIG. 2, the controller 40 serves to control the feeder portion 20, the conveying mechanism 30 and the image forming portion 10 in order to form an image on the sheet based on image forming data D1 transmitted through an electrical communication line from an external computer 2. Moreover, the controller 40 incorporated therein the image forming data preprocessing system 100 for preprocessing the image forming data D1 transmitted from the computer 2, which will be described below in detail.

In the case in which the image forming data preprocessing system 100 executes a suppression processing which will be described below, the image forming data D1 are converted into image forming data D2 and the controller 40 controls the feeder portion 20, the conveying mechanism 30 and the image forming portion 10 based on the image forming data D2.

3. Feeder Portion

As shown in FIG. 1, the feeder portion 20 includes a sheet feeding tray 21 accommodated in a lowermost part of the housing 3, a feed roller 22 provided above a front end of the sheet feeding tray 21 and serving to feed (convey) sheets stacked on the sheet feeding tray 21 to the image forming portion 10, and a separating pad 23 for separating the sheets, fed by the feed roller 22, one by one by giving a predetermined conveying resistance to the sheet.

Conveying rollers 24 and 25 are disposed in a substantially U-shape curved portion, i.e. an upstream portion of a sheet conveying path P extending from the sheet feeding tray 21 via the image forming portion 10 to the sheet discharging tray 5. The conveying roller 24 and 25 apply a conveying force to the sheet conveyed toward the image forming portion 10 while being bent into a substantially U-shape.

Registration rollers 26 and 27 are disposed in the conveying path P at downstream side from the conveying roller 24. The registration rollers 26 and 27 come in contact with a leading end of the sheet conveyed by the conveying roller 24 to correct a skew of the sheet, and the registration rollers 26 and 27 further convey the sheet toward the image forming portion 10.

4. Conveying Mechanism

The conveying mechanism 30 includes a conveying belt 33 disposed between the sheet feeding tray 21 and the image forming portion 10, and a discharge chute (not shown) and a discharge roller 91, both located behind the image forming portion 10.

The conveying belt 33 is suspended between a driving roller 31 and a driven roller 32 for circulation. The driving roller 31 is rotated in synchronous with an operation of the image forming portion 10, and the driven roller 32 is rotatably provided at a position spaced apart from the driving roller 31.

The conveying mechanism 30 sequentially conveys the sheet from the feeder portion 20 to the image forming portion 10 having four process cartridges 70K, 70Y, 70M and 70C by rotating the conveying belt 33 with the sheet placed thereon. The conveying mechanism 30 further conveys the sheet, on which an image is formed by the image forming portion 10, to a discharge portion 7 along the conveying path P by the discharge chute and the discharge roller 91, and discharges the sheet from the discharging portion 7 to the sheet discharging tray 5.

A cleaning device 110 for removing a waste toner deposited on a surface of the conveying belt 33 is provided below the conveying mechanism 30.

5. Image Forming Portion

As shown in FIG. 1, the image forming portion 10 includes a scanner portion 60, the process cartridge 70 and a fixing unit 80.

5.1. Scanner Portion

The scanner portion 60 is disposed at an upper part in the housing 3 and includes a laser beam source, a polygon mirror, an fθ lens and reflecting mirrors.

A laser beam emitted from the laser beam source is deflected by the polygon mirror and passes through the fθ lens, and an optical path is then folded back by the reflecting mirror, and furthermore, is bent downward by the reflecting mirror so that the laser beam is irradiated on a surface of a photosensitive member 71 provided in each of the four process cartridges 70K, 70Y, 70M and 70C to form an electrostatic latent image thereon.

5.2. Process Cartridge

The four process cartridges 70K, 70Y, 70M and 70C contain respective toners of different colors, but have the same structure. Therefore, the structure of the process cartridge 70C will be described as an example.

The process cartridge 70 has a casing 75 accommodating the photosensitive member 71, a charger 72 and a toner cartridge 74 therein.

Moreover, a transfer roller 73 is rotatably disposed at an opposite side to the photosensitive member 71 with the conveying belt 33 interposed therebetween. The transfer roller 73 serves to transfer a toner from a surface of the photosensitive member 71 to the sheet when the sheet passes through the vicinity of the photosensitive member 71.

The toner cartridge 74 includes a toner chamber 74A containing the toner therein, a feed roller 74B for feeding the toner to a developing roller 74C, and the developing roller 74C. The toner in the toner chamber 74A is fed to the developing roller 74C side by a rotation of the feed roller 74B, and furthermore, the toner fed to the developing roller 74C side is carried on a surface of the developing roller 74C and a thickness of the carried toner is regulated by a thickness regulating blade 74D to a predetermined uniform thickness, and the toner is then fed to the surface of the photosensitive member 71.

5.3. Fixing Unit

The fixing unit 80 is disposed in the conveying path P at a downstream side from the photosensitive member 71, and includes a heating roller 81 and a pressing roller 82.

The fixing unit 80 serves to heat and melt the toner, transferred onto the sheet, by the heating roller 81 and the pressing roller 82 to thereby fix the toner on the sheet.

5.4. Image Forming Operation

The image forming portion 10 described above forms an image on a sheet in the following fashion. In response to an image formation start command, the controller 40 controls the feeder portion 20 and the conveying mechanism 30 to convey the sheet to the image forming portion 10, and furthermore, controls the scanner portion 60 and the process cartridges 70K, 70Y, 70M and 70C in the image forming portion 10 based on the image forming data D1 (or the image forming data D2 subjected to the suppression processing). Therefore, as the photosensitive member 71 is rotated, the surface of the photosensitive member 71 is uniformly charged positively by the charger 72 and is then exposed to a laser beam irradiated from the scanner portion 60. As a result, an electrostatic latent image corresponding to the image forming data D1 (or the image forming data D2 subjected to the suppression processing) is formed on the surface of the photosensitive member 71.

When the toner carried on the developing roller 74C and charged positively is opposed to and comes in contact with the photosensitive member 71 by the rotation of the developing roller 74C, the toner is fed to the electrostatic latent image formed on the surface of the photosensitive member 71. Consequently, the electrostatic latent image of the photosensitive member 71 is changed into a visible toner image by reversal development, and the toner image is carried on the surface of the photosensitive member 71.

The toner image carried on the surface of the photosensitive member 71 is transferred onto the sheet through a transfer bias applied to the transfer roller 73. The sheet having the toner image transferred thereto is conveyed to the fixing unit 80 and is heated, and the toner transferred as the toner image is fixed to the sheet, so that the image formation is completed.

To avoid excessive consumption of a toner, the laser printer 1 includes the image forming data preprocessing system 100. The image forming data preprocessing system 100 will be described below in detail.

6. Image Forming Data Preprocessing System

As shown in FIG. 2, the image forming data preprocessing system 100 is incorporated in the controller 40. The system 100 is a software module for preprocessing the image forming data D1 transmitted from the computer 2 to the laser printer 1. The software module can be preliminary incorporated in the controller 40. Alternatively, the software module can be delivered, as a software program, to a user by way of a carrier, such as a floppy diskette, a CD, a DVD, a memory and a signal, carrying the software program therein, so that the user can install the software program into the laser printer 1 to add the software module to the laser printer 1 as an upgrade.

The image forming data D1 generally contain plural types of objects including, but not limited to, text data, outline data and bit map data. For simplifying the explanation in the following description, it is assumed that the image forming data D1 contain three types of objects, i.e. text data (for example, T) that use codes for specifying an image to be generated, outline data (for example, L) that use coordinates and segments for specifying an image to be generated, and bit map data (for example, B) that designate pixels for specifying an image to be generated as shown in FIG. 2. Moreover, the text data, the outline data and the bit map data can include chromatic color data, respectively.

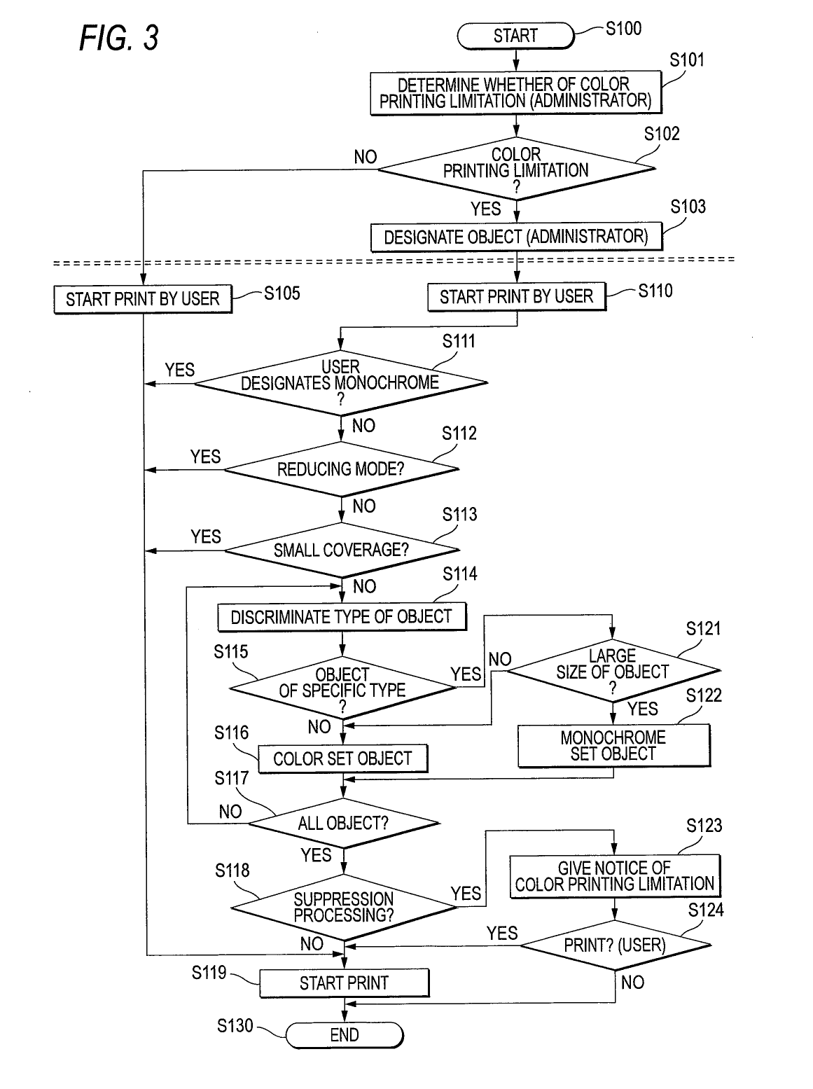

The image forming data preprocessing system 100 executes Steps S100 to S130 shown in a flowchart of FIG. 3. The image forming data preprocessing system 100 includes plural function blocks, such as a designating block (Step S103), a deciding block (Step S115), a suppressing block (Step S122) and a selecting block (Step S102 or Step S124).

The designating block (Step S103) causes a user (an administrator) to designate an object of a specific type, which is a target to be considered by the deciding block (Step S115), from three types of objects of the text data, the outline data and the bit map data which can be contained in the image forming data D1. One or more specific object types may be designated.

The deciding block (Step S115) decides whether the object of the specific type is present in the objects of the image forming data D1 or not. That is, the deciding block decides whether the image forming data D1 contain the designated specific type object or not. The suppressing block (Step S122) executes a suppression processing when the deciding block (Step S115) decides that the object of the specific type is present. The suppression processing includes converting at least a part of the image forming data D1 so as to suppress consumption of a toner to be used when the laser printer 1 forms a color image.

The selecting block (Step S102 or Step S124) causes the user (or the administrator) to select whether the suppression processing can be executed or not.

The image forming data preprocessing system 100 will be described below for each of the Steps S100 to S130.

When the laser printer 1 is started or a command related to a print is transmitted from the computer 2, the image forming data preprocessing system 100 is started at the Step S100 and an initial setting is executed in the following manner at the Steps S101 to S103. When the image forming data preprocessing system 100 receives the image forming data D1 from the computer 2, the image forming data preprocessing system 100 analyzes the image forming data D1 and gets information relating to the objects included in the image forming data D1, such as the number of objects, the each object data amount and an area for displaying the each object. And the image forming data preprocessing system 100 stores the information. The image forming data preprocessing system 100 executes the above-described process before starting the print operation.

At the Step S101, an inquiry about the presence of a printing limitation of a color image is given to the user (administrator) to make a decision (“image formation” will be hereinafter referred to as “print”). In this case, the inquiry is given to the user (administrator) through the computer 2 which is connected through the electrical communication line to the laser printer 1 and can be operated by the user (administrator), and the user (administrator) inputs the presence of the color image printing limitation to the computer 2 so that the contents of the input are transferred to the controller 40. If there is no input from the user (administrator), a last decision is exactly held. The user (administrator) may directly manipulate an operation panel (not shown) provided on the controller 40 of the laser printer 1 to carry out the input.

At the Step S102, if it is decided that the color image printing limitation is not present, the system 100 proceeds to the Step S105 and awaits a printing command from the user. If the printing command is given from the computer 2 operated by the user at the Step S105, the system 100 proceeds to the Step S119 at which the controller 40 starts printing without the color image printing limitation and as desired by the user. At the Step S130, the processing of the image forming data preprocessing system 100 is ended.

On the other hand, if it is decided that the color image printing limitation is present at the Step S102, the system 100 proceeds to the Step S103. At the Step S103, an inquiry is given to cause the user (administrator) to designate an object of a specific type, which is a target to be considered by the deciding block (Step S115), from the three types of objects of the text data, the outline data and the bit map data which can be contained in the image forming data D1. The inquiry is given to the user (administrator) through the computer 2 which can be operated by the user (administrator). If the user (administrator) designates and inputs, to the computer 2, the specific type object, the contents of the input are transmitted to the controller 40. In this embodiment, the following description will be given on the assumption that the user (administrator) designates the text data as the specific type object.

If the user (administrator) does not carry out an input, a last designation is exactly held. Moreover, if the user (administrator) desires to change the contents initially set, the Steps S101 to S103 can be executed at any time in addition to the start to change the initially set contents

The system 100 proceeds to the Step S110 at which the system 100 awaits a printing command given from the user. At the Step S110, if the printing command is given from the computer 2 operated by the user, the system 100 proceeds to the Step S111.

If it is decided that the printing command given from the user designates a monochromatic print at the Step S111, the system 100 proceeds to the Step S119 at which the controller 40 starts the monochromatic print and the processing of the image forming data preprocessing system 100 is ended at the Step S130.

On the other hand, if it is decided that the printing command given from the user does not designate the monochromatic print at the Step S111, the system 100 proceeds to the Step S112.

If it is decided that the printing command given from the user is in a reducing mode having a predetermined reduction ratio or less at the Step S112, the system 100 proceeds to the Step S119 at which the controller 40 starts the reducing print without executing the color image printing limitation, and the processing of the image forming data preprocessing system 100 is ended at the Step S130. The predetermined reduction ratio may be optionally set by the user in consideration of the effect of suppressing toner consumption.

On the other hand, if it is decided that the print command given from the user is not in the reducing mode having the predetermined reduction ratio or less at the Step S112, the system 100 proceeds to the Step S113.

If it is decided that a coverage, which is a rate of a region where an image is actually formed relative to an image formable region, is equal to or smaller than a predetermined value at the Step S113, the system 100 proceeds to the Step S119 at which the controller 40 starts the print without executing the color image printing limitation. At the Step S130, the processing of the image forming data preprocessing system 100 is ended. The predetermined value in the Step S113 may be optionally set by the user in consideration of the effect of suppressing the toner consumption of the toner.

On the other hand, if it is decided that the coverage is not equal to or smaller than the predetermined value at the Step S113, the system 100 proceeds to the Step S114.

Subsequently, the objects contained in the image forming data D1 are extracted one by one and the type of the object thus extracted is discriminated at the Step S114.

If it is decided at the Step S115 that the extracted object is not the specific object (the text data in this example) designated in the Step S103, the system 100 proceeds to the Step S116. At the Step S116, chromatic color data of the extracted object are not converted into achromatic color data and color setting for the extracted object is maintained, and the system 100 proceeds to the Step S117.

On the other hand, if it is decided at the Step S115 that the extracted object is the specific object (the text data in this example) designated at the Step S103, the system 100 proceeds to the Step S121.

If it is decided that a size of the extracted object (an actual dimension, a font size or the number of characters in case of the text data) is equal to or smaller than a predetermined size at the Step S121, then, the system 100 proceeds to the Step S116.

The chromatic color data of the extracted object are not converted into the achromatic color data and color setting for the extracted object is maintained at the Step S116, and the system 100 proceeds to the Step S117. The predetermined size may be optionally set by the user in consideration of the effect of suppressing the toner consumption.

On the other hand, if it is decided that the size of the extracted object is greater than the predetermined size at the Step S121, the system 100 proceeds to the Step S122.

Subsequently, monochrome setting for converting the chromatic color data of the extracted object into the achromatic color data is carried out at the Step S122, and the system 100 proceeds to the Step S117. “The monochrome setting” i.e. the conversion of the chromatic color data of the extracted object into the achromatic color data is an example of “the suppression processing of converting at least a part of the image forming data D1 so as to enable the suppression of the consumption of the toner to be used when the laser printer 1 forms a color image”.

When the system 100 proceeds from the Step S116 or the Step S122 to the Step S117, it is decided whether the Steps S114 and S115 are executed for all of the objects contained in the image forming data D1 or not at the Step S117. If it is decided that they are not executed for all of the objects, the system 100 returns to the Step S114, and the Steps S114 and S115 are executed for the residual objects.

On the other hand, if it is decided that the Steps S114 and S115 are executed for all of the objects contained in the image forming data D1 at the Step S117, the system 100 proceeds to the Step S118.

If it is decided that the suppression processing of the Step S122 is not executed at the Step S118, the system 100 proceeds to the Step S119. At the Step S119, the print is started based on the image forming data D1 over which the suppression processing is not executed. At the Step S130, the processing of the image forming data preprocessing system 100 is ended.

On the other hand, if it is decided at the Step S118 that the suppression processing of the Step S122 is executed for at least a part of the image forming data D1, the system 100 proceeds to the Step S123. In this stage, a necessary processing for the monochrome setting has been executed at the Step S122 for all of the required objects of the image forming data D1, and thus the image forming data D2 have been already obtained as a consequence of subjecting the image forming data D1 to the suppression processing.

At the Step S123, a notice indicating that “the color printing limitation is executed” is given to the computer 2 operated by the user and an inquiry whether the user still desires to start the print is given to the user. Thereafter, the system 100 proceeds to the Step S124 to await user's input. At this time, the user inputs, to the computer 2, whether the user desires to start the print or not, and the contents of the input are transmitted to the controller 40. The user may directly manipulate the operation panel (not shown) provided on the controller 40 of the laser printer 1 to carry out the input.

If it is decided that the user rejects the printing start at the Step S124, the system 100 proceeds to the Step S130 and the processing of the image forming data preprocessing system 100 is ended without the print carried out.

On the other hand, if it is decided that the user permits the printing start at the Step S124, the system 100 proceeds to the Step S119. At the Step S119, the print is started based on the image forming data D2 obtained as a consequence of executing the suppression processing over the image forming data D1. At the Step S130, the processing of the image forming data preprocessing system 100 is ended.

The image forming data preprocessing system 100 according to the first embodiment executes the suppression processing if necessary by the deciding block (Step S115) and the suppressing block (Step S122) for the image forming data D1 transmitted to the laser printer 1. Therefore, it is possible to suppress the consumption of the toner in the laser printer 1.

The image forming data preprocessing system 100 does not simply convert data on one color included in image forming data into data on another color differently from the background art. In the case in which the user needs that text data may be subjected to the suppression processing but the outline data and the bit map data should not be subjected to the suppression processing, the image forming data preprocessing system 100 can take such a countermeasure that the text data are subjected to a monochrome conversion and the outline data and the bit map data are not subjected to a color conversion. Thus, it is possible to easily meet various needs of the user.

Accordingly, the image forming data preprocessing system 100 in accordance with the first embodiment can suppress the consumption of the toner in the laser printer 1 while meeting the needs of the user.

In the image forming data preprocessing system 100, moreover, the suppressing block (Step S122) serves to convert the chromatic color data of the image forming data D1 into the achromatic color data. Therefore, although the print image formed by the laser printer 1 under the suppression processing may be visually inferior in comparison with the color image, the user can more easily imagine and specify the color image from the monochrome grayscale image as compared with the background art in which one color is simply converted into another color. Therefore, it is possible to meet the needs of the user more easily in comparison with the background art.

In the case in which an object of a specific type that a user wants to designate is different from an object of a specific type that another user wants to designate, the image forming data preprocessing system 100 can properly change the designation by the designating block (Step S103) and can meet the needs of the user more easily.

The image forming data preprocessing system 100 can discriminate the text data, the outline data and the bit map data as the objects of plural types which are included in the image forming data D. Therefore, it is possible to reliably produce the functions and effects of the invention.

The image forming data preprocessing system 100 can limit the color print only when the user desires the execution of the suppression processing by the selecting block (Step S102 or Step S124). Therefore, it is possible to meet the needs of the user still more easily. At the Step S102, the administrator previously decides the necessity of the execution of the suppression processing. At the Step S124, the user giving the printing command decides the necessity of the print under the suppression processing. Accordingly, the image forming data preprocessing system 100 can provide various selections depending on a responsibility of the user with regard to the execution of the suppression processing.

The suppressing block (Step S122) of the image forming data preprocessing system 100 does not execute the suppression processing over objects of different types from the object of the specific type. Therefore, it is possible to minimize an influence such as a reduction in an information value of an image which is caused by the suppression processing. Thus, it is possible to reduce discomfort felt by the user.

The suppressing block (Step S122) of the image forming data preprocessing system 100 does not execute the suppression processing for the object of the specific type if the index (the reduction ratio, the coverage or the size) indicative of the size of the object of the specific type is equal to or smaller than a predetermined value (the decision at the Step S112, the Step S113, the Step S115 and the Step S121). Therefore, the image forming data preprocessing system 100 does not carry out the suppression processing when the size of the object of the specific type is so small that the suppression processing does not need to be carried out. Consequently, it is possible to eliminate an excessive suppression processing.

(First Modification)

As a first modification, it is possible to replace the suppressing block (Step S122) of the image forming data preprocessing system 100 according to the first embodiment with a function block of carrying out the suppression processing by decreasing an amount of use of a toner every pixel unit. In this case, it is also possible to modify the function block such that a color image is not converted into a monochromatic image. The suppression processing of decreasing the amount of use of the toner every pixel unit can be executed, for example, by a method of reducing an amount of exposure to the photosensitive body 71 of the image forming portion 10, thereby decreasing an amount of transfer of the toner.

In this case, only a density of an image printed by the laser printer 1 is reduced, and the image can be printed as a color image close to the original image, and discomfort felt by the user can be significantly reduced.

In addition to the suppressing block (Step S122) according to the first embodiment, the suppressing block (Step S122) may additionally has a second suppressing block for carrying out a suppression processing of decreasing the amount of use of the toner every pixel unit.

(Second Modification)

As a second modification, it is possible to replace the suppressing block (Step S122) of the image forming data preprocessing system 100 according to the first embodiment with a function block of carrying out a suppression processing by reducing a resolution of image forming data.

In this case, although the print image of the laser printer 1 is coarse, the print image can be a color image closer to the original image, and discomfort felt by the user can be significantly reduced.

(Third Modification)

Since the image forming data preprocessing system 100 according to the first embodiment is a software module, the image forming data preprocessing system 100 can be provided in the computer 2, not in the controller 40 of the laser printer 1. In this connection, the software module can be delivered, as a software program, to the user by way of a carrier, such as a floppy diskette, a CD, a DVD, a memory and a signal, carrying the software program therein, so that the user can install the software program into the computer 2 to add the software module to the laser printer 1.

In this case, the computer 2 can preprocess the image forming data D1 and then transmit the image forming data D1 or D2 from the computer 2 to the laser printer 1. By the functions and effects of the image forming data preprocessing system 100, it is possible to suppress the amount of the toner consumed by the laser printer 1.

(Fourth Modification)

As a fourth modification, it is possible to replace the suppressing block (Step S122) of the image forming data preprocessing system 100 according to the first embodiment with a function block of carrying out the suppression processing by deleting the object of the specific type (executing no print). It is possible to effectively implement the suppression of the consumption amount of the toner.

### Second Embodiment

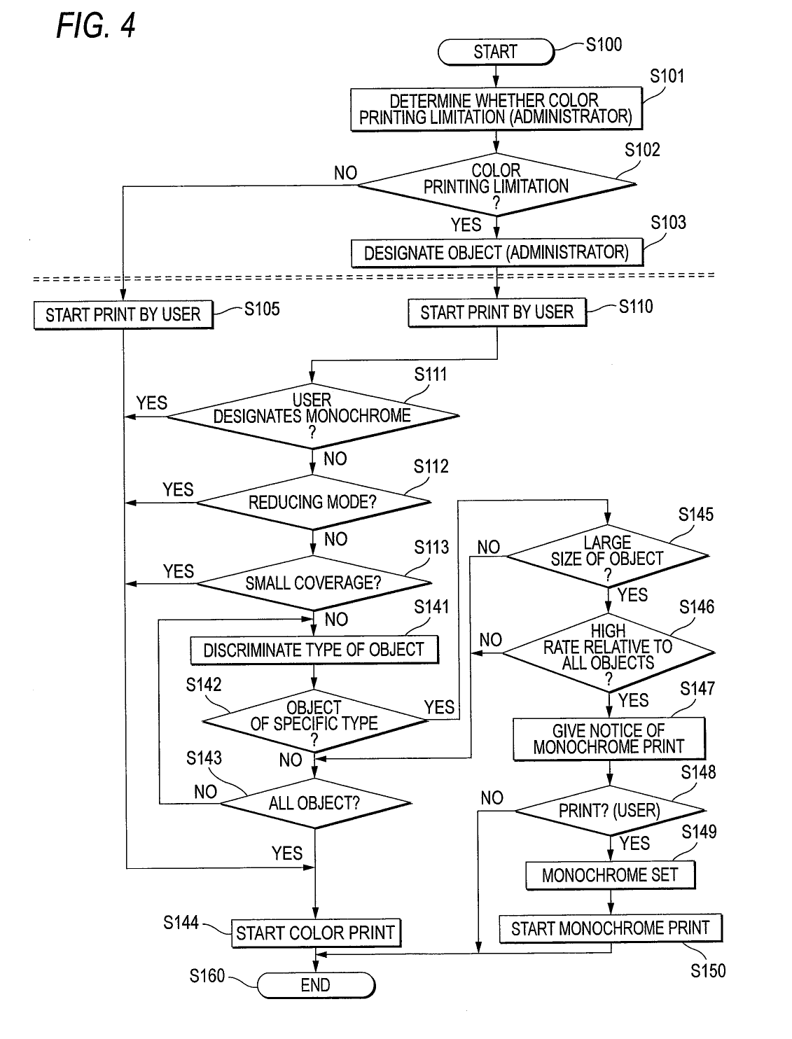

As shown in FIG. 4, in an image forming data preprocessing system according to a second illustrative, non-limiting embodiment employs Steps S141 to S160 in place of the Steps S114 to S130 of the image forming data preprocessing system 100 according to the first embodiment. The other structures are the same as those of the image forming data preprocessing system 100 according to the first embodiment. Accordingly, the Steps S141 to S160 of the second embodiment will be mainly described and the other structures have the same reference numerals, and description will be omitted or simplified.

In the image forming data preprocessing system according to the second embodiment, the Step S142 functions as a deciding block, the Step S149 functions as a suppressing block, and the Step S103 or the Step S148 functions as a selecting block.

In the case in which there is no printing limitation of a color image at Step S102, the image forming data preprocessing system proceeds to Step S105 at which the system awaits a printing command given from a user. If the printing command is given from a computer 2 operated by a user at the Step S105, the system proceeds to the Step S144 at which a controller 40 starts a color print as desired by the user without executing a printing limitation. At the Step S160, the processing of the image forming data preprocessing system is ended.

On the other hand, if there is the printing limitation of the color image at the Step S102, the system proceeds to Step S110 at which the system awaits a printing command given from the user. If the printing command is given from the computer 2 operated by the user at the Step S110, Steps S111 to S113 are executed. As a result, if it is decided that the printing limitation of the color image is not carried out, the system proceeds to the Step S144.

Subsequently, the controller 40 starts the color print without executing the printing limitation of the color image at the Step S144, and the processing of the image forming data preprocessing system is ended at the Step S160.

On the other hand, if it is decided that it is necessary to carry out the color image printing limitation through the Steps S111 to S113, the system proceeds to the Step S141.

Objects contained in image forming data D1 are extracted one by one and the types of the objects thus extracted are discriminated at the Step S141.

If it is decided at the Step S142 that the extracted object is not a specific object (text data in this example) designated in the Step S103, the system proceeds to the Step S143.

On the other hand, if it is decided at the Step S142 that the extracted object is the specific object (the text data in this example) designated in the Step S103, the system proceeds to the Step S145.

If it is decided that a size of the extracted object (an actual dimension or the like) is equal to or smaller than a predetermined size at the Step S145, the system proceeds to the Step S143. The predetermined size may be optionally set by the user in consideration of the effect of suppressing the consumption of the toner.

On the other hand, if it is decided that the size of the extracted object is greater than the predetermined size at the Step S145, the system proceeds to the Step S146.

If it is decided that a rate of the number or area of the objects of the specific type to all of the extracted objects is equal to or lower than a predetermined rate at the Step S146, the system proceeds to the Step S143. The predetermined rate may be set optionally by the user in consideration of the effect of suppressing the consumption of the toner.

On the other hand, if it is decided that the rate of the number or area of the objects of the specific type to all of the extracted objects is higher than the predetermined rate at the Step S146, the system proceeds to the Step S147.

When the system proceeds from the Step S142, the Step S145 or the Step S146 to the Step S143, it is decided whether the Steps S141 and S142 are executed for all of the objects contained in the image forming data D1 or not at the Step S143. If it is decided that all of the objects are not executed, the system returns to the Step S141, and the Steps S141 and S142 are executed for the residual objects.

On the other hand, if it is decided that the Steps S141 and S142 are executed for all of the objects contained in the image forming data D1 at the Step S143, the system proceeds to the Step S144.

Then, the controller 40 starts the color print without executing the color image printing limitation at the Step S144, and the processing of the image forming data preprocessing system is ended at the Step S160.

On the other hand, when the system proceeds from the Step S146 to the Step S147, a notice indicating that “the color print is converted into the monochrome print” is given to the computer 2 operated by the user at the Step S147 and an inquiry whether the user desires the converted monochrome print is given to the computer 2, and then the system proceeds to the Step S148 to await user's input.

If it is decided that the user rejects the start of the monochrome print at the Step S148, the system proceeds to the Step S160 and the processing of the image forming data preprocessing system 100 is ended without the print.

On the other hand, if it is decided that the user permits the start of the monochrome print at the Step S148, the system proceeds to the Step S149. At the Step S149, the system 100 executes monochrome setting by converting all chromatic color data of the image forming data D1 entirely into achromatic color data. This way, image forming data D2 can be obtained as a consequence of subjecting the image forming data D1 to the suppression processing.

The monochrome print is started based on the image forming data D2 at the Step S150, and the processing of the image forming data preprocessing system 100 is ended at the Step S160.

The image forming data preprocessing system according to the second embodiment can also produce the advantages similarly to the image forming data preprocessing system 100 according to the first embodiment.

The suppressing block (Step S149) of the image forming data preprocessing system carries out the suppression processing over the entire image forming data D1. Therefore, it is possible to suppress the consumption of the toner more effectively than the image forming data preprocessing system 100 according to the first embodiment.

The modifications described in connection with the first embodiment can also be applied to the second embodiment. For example, the suppressing block (Step S149) of the image forming data preprocessing system 100 according to the second embodiment can be replaced with a function block of carrying out the suppression processing by decreasing an amount of use of the toner every pixel unit as described in connection with the first modification. In this case, it is also possible to modify the function block such that a color image is not converted into a monochromatic image. In addition to the suppressing block (Step S149) according to the second embodiment, it is also possible to provide a second suppressing block for carrying out the suppression processing of decreasing the amount of use of the toner every pixel unit.

As described in connection with the second modification, the suppressing block (Step S149) of the image forming data preprocessing system 100 according to the second embodiment can be replaced with the function block of carrying out a suppression processing by reducing a resolution of the image forming data.

As described in connection with the third modification, the image forming data preprocessing system 100 according to the second embodiment can be provided in the computer 2.

The present invention can provides the following illustrative, non-limiting embodiments:

(1) An image forming data preprocessing system for preprocessing image forming data transmitted to or to be transmitted to an image forming apparatus for forming an image on a recording medium, including deciding means for deciding whether an object of a specific type is present in objects constituting the image forming data or not, and suppressing means for carrying out a suppression processing of converting at least a part of the image forming data in such a manner that consumption of a colorant to be used when the image forming apparatus forms a color image can be suppressed if the deciding means decides that the object of the specific type is present.

In the image forming data preprocessing system according to (1), the image forming data transmitted to or to be transmitted to the image forming apparatus are subjected to the suppression processing based on whether the object of the specific type is present in the objects constituting the image forming data by the deciding means and the suppressing means. The image forming apparatus can form an image on the recording medium based on image forming data obtained through the suppression processing. Therefore, it is possible to suppress the consumption of the colorant.

Accordingly, the image forming data preprocessing system according to (1) can suppress the consumption of the colorant in the image forming apparatus while meeting the needs of a user.

As an example of converting at least a part of the image forming data, it is possible to employ various methods in which a specific color is converted into another color for only the object of the specific type, a color density is reduced for only the object of the specific type, the specific color is converted into another color for the entire image forming data, the color density is reduced for the entire image forming data, etc.

(2) The image forming data preprocessing system according to (1), in which the suppressing means can convert chromatic color data of the image forming data into achromatic color data when carrying out the suppression processing.

According to the image forming data preprocessing system according to (2), a color image (a chromatic image) is converted into a monochromatic image (an achromatic image, a monochrome gray image) by the suppression processing. Although the image formed on the recording medium by the image forming apparatus is visually inferior in comparison with the color image, a user can more easily imagine and specify the color image from the monochrome gray image in comparison with the background art in which a specific color is simply converted into another color. Therefore, it is possible to meet the needs of the user more easily in comparison with the background art.

(3) The image forming data preprocessing system according to (1) or (2), further including designating means for causing a user to designate an object of a specific type from plural types of objects.

According to the image forming data preprocessing system in accordance with (3), in the case in which an object of a specific type that a user wants to designate is different from an object of a specific type that another user wants to designate, it is possible to take a countermeasure well.

(4) The image forming data preprocessing system according to any one of (1) to (3), in which the plural types of objects include at least two of text data, outline data and bit map data.

There is a high possibility that at least two of text data, outline data and bit map data are actually included as objects in the image forming data. Therefore, the image forming data preprocessing system of (4) can effectively produce practical advantages.

(5) The image forming data preprocessing system according to any one of (1) to (4), further including selecting means for causing the user to select whether the suppression processing can be executed or not.

The image forming data preprocessing system of (5) suppresses the formation of a color image only in the case in which the user gives a permission. Therefore, it is possible to meet the needs of the user still more easily.

(6) The image forming data preprocessing system according to any one of (1) to (5), in which the suppressing means can carry out the suppression processing for only the object of the specific type.

In the image forming data preprocessing system of (6), objects of different types from the object of the specific type are not subjected to the suppression processing. Therefore, it is possible to minimize an influence such as a reduction in an information value of an image which is caused by the suppression processing. Thus, it is possible to reduce discomfort felt by the user.

(7) The image forming data preprocessing system according to (6), in which the suppressing means do not carry out the suppression processing for the object of the specific type if an index indicative of a size of the object of the specific type, which is decided to be present by the deciding means, is equal to or smaller than a predetermined value.

In the image forming data preprocessing system of (7), if the object of the specific type has such a small size that the suppression processing does not need to be carried out, the suppression processing is not performed. Therefore, it is possible to eliminate an excessive suppression processing.

The index indicative of the size of the object of the specific type includes various indices which directly or indirectly indicate the size of the object of the specific type, for example, an actual dimension or a font size (a size), a rate (a ratio) of the object of the specific type to all of the objects and a rate (a coverage) of a region in which an image is actually formed to an image formable region.

(8) The image forming data preprocessing system according to any one of (1) to (5), in which the suppressing means carry out a suppression processing for the entire image forming data.

The image forming data preprocessing system of (8) carries out the suppression processing over the entire image forming data. Therefore, it is possible to suppress the consumption of the colorant more effectively.

(9) The image forming data preprocessing system according to (8), in which the suppressing means do not carry out the suppression processing for the entire image forming data if an index indicative of a size of the object of the specific type, which is decided to be present by the deciding means, is equal to or smaller than a predetermined value.

In the image forming data preprocessing system of (9), if the object of the specific type has such a small size that the suppression processing does not need to be carried out, the suppression processing is not performed. Therefore, it is possible to eliminate an excessive suppression processing.

(10) The image forming data preprocessing system according to any one of (1) to (9), in which the suppressing means carry out the suppression processing by decreasing an amount of use of the colorant every pixel unit.

According to the image forming data preprocessing system of (10), although the density of the image formed by the image forming apparatus is reduced, the color image can be prevented from being disturbed. Thus, it is possible to reduce discomfort felt by the user.

An example of a method of decreasing an amount of use of the colorant every pixel unit includes, in a case of a laser printer, a method of reducing an irradiation in an exposure to a photosensitive body, thereby decreasing an amount of transfer of a toner and, in a case of an ink jet printer, a method of decreasing an ejection amount of ink droplet per dot.

(11) The image forming data preprocessing system according to any one of (1) to (10), in which the suppressing means carry out the suppression processing by reducing a resolution of the image forming data.

According to the image forming data preprocessing system of (11), although an image formed by the image forming apparatus may be coarse, it is possible to prevent the color image from being disturbed, thereby reducing discomfort felt by the user.

(12) An image forming apparatus which includes the image forming data preprocessing system according to any one of (1) to (11), and which forms an image on the recording medium based on image forming data obtained through preprocessing by the image forming data preprocessing system.

In the image forming apparatus according to (12), it is possible to reliably implement the suppression of the consumption of the colorant by the functions and effects of the image forming data preprocessing system.

(13) A computer which includes the image forming data preprocessing system according to any one of (1) to (11), and which preprocesses the image forming data, transmitted to or to be transmitted to the image forming apparatus, through the image forming data preprocessing system.

In the computer according to (13), it is possible to reliably implement the suppression of the consumption of the colorant in the image forming apparatus by the functions and effects of the image forming data preprocessing system.

While the invention has been described based on the first and second examples, it is not restricted to the first and second examples but it is apparent that changes can be properly made for an application without departing from the scope thereof.

### FIG. 3

(S100) Start
(S101) Determine whether of color printing limitation (administrator)
(S102) Color printing limitation?
(S103) Designate object (administrator)
(S105) Start print by user
(S110) Start print by user
(S111) User designates monochrome?
(S112) Reducing mode?
(S113) Small coverage?
(S114) Discriminate type of object
(S115) Object of specific type?
(S116) Color set object
(S117) All object?
(S118) Suppression processing?
(S119) Start print
(S121) Large size of object?
(S122) Monochrome set object
(S123) Give notice of color printing limitation
(S124) Print? (user)
(S130) End

### FIG. 4

(S100) Start
(S101) Determine whether color printing limitation (administrator)
(S102) Color printing limitation?
(S103) Designate object (administrator)?
(S105) Start print by user
(S110) Start print by user
(S111) User designates monochrome?
(S112) Reducing mode?
(S113) Small coverage?
(S141) Discriminate type of object
(S142) Object of specific type?
(S143) All object?
(S144) Start color print
(S145) Large size of object?
(S146) High rate relative to all objects?
(S147) Give notice of monochrome print
(S148) Print? (user)
(S149) Monochrome set
(S150) Start monochrome print
(S160) End

What is claimed is:

1. An image forming data preprocessing system for preprocessing first image forming data, the system comprising:
a deciding block for deciding whether the first image forming data contains an object of a specific type or not; and
a suppressing block for executing a suppression processing if the deciding block decides that the first image forming data contains the object of the specific type, the suppression processing including converting at least a part of the image forming data to provide second image forming data,
wherein the second image forming data is smaller in a required colorant consumption amount than the first image forming data.

2. The image forming data preprocessing system according to claim 1, wherein the suppressing block converts chromatic color data of the first image forming data into achromatic color data to provide the second image forming data.

3. The image forming data preprocessing system according to claim 1, further comprising a designating block for designating the specific type from plural object types.

4. The image forming data preprocessing system according to claim 3, wherein the plural object types include at least two of text data, outline data and bit map data.

5. The image forming data preprocessing system according to claim 1, further comprising a selecting block for selectively enabling or disabling the suppression processing.

6. The image forming data preprocessing system according to claim 1, wherein the suppressing block converts the object of the specific type contained in the first image forming data and does not convert an object of another different type contained in the first image forming data, to provide the second image data.

7. The image forming data preprocessing system according to claim 6, further comprising a disabling block for disabling the suppression processing for the object of the specific type if an index indicative of a size of the object of the specific type contained in the first image forming data is not larger than a predetermined value.

8. The image forming data preprocessing system according to 1, wherein the suppressing block converts the entire first image forming data to provide the second image forming data.

9. The image forming data preprocessing system according to claim 8, further comprising a disabling block for disabling the suppression processing for the entire first image forming data if an index indicative of a size of the object of the specific type contained in the first image forming data is not larger than a predetermined value.

10. The image forming data preprocessing system according to claim 1, wherein the suppression processing includes decreasing the required colorant consumption amount every pixel unit.

11. The image forming data preprocessing system according to claim 1, wherein the suppression processing includes reducing a resolution.

12. An image forming apparatus which receives first image forming data, the apparatus comprising:
a deciding block for deciding whether the first image forming data contains an object of a specific type or not;
a suppressing block for executing a suppression processing if the deciding block decides that the first image forming data contains the object of the specific type, the suppression processing including converting at least a part of the image forming data to provide a second image forming data, wherein the second image forming data is smaller in a required colorant consumption amount than the first image forming data; and
an image forming block for forming an image on a recording medium based on the second image forming data.

13. A computer for preprocessing first image forming data, the computer comprising:
a deciding block for deciding whether the first image forming data contains an object of a specific type or not;
a suppressing block for executing a suppression processing if the deciding block decides that the first image forming data contains the object of the specific type, the suppression processing including converting at least a part of the image forming data to provide second image forming data, wherein the second image forming data is smaller in a required colorant consumption amount than the first image forming data; and
a transmitting block for transmitting the second image forming data to an image forming apparatus to cause the image forming apparatus to form an image on a recording medium.

14. A carrier carrying a software program readable and executable by a hardware to perform a function comprising the steps of
receiving first print data and a color print command;
extracting, in response to the color print command, an object from the first print data;
deciding whether the extracted object is of a predetermined object type or not, and providing a conversion command if the extracted object is of the predetermined object type; and
converting, in response to the conversion command, at least the extracted object to provide second print data based on the first print data, the second print data being smaller in required colorant consumption amount than the first print data.
